(19) United States
(12) Patent Application Publication
(10) Pub. No.: US 2008/0109844 A1
(43) Pub. Date: May 8, 2008

(54) Playing video content with advertisement

(75) Inventors: David Baldeschwieler, San Francisco, CA (US); Philip J. Kaplan, San Francisco, CA (US); Gidon Wise, San Francisco, CA (US)

Correspondence Address: VAN PELT, YI & JAMES LLP, 10050 N. FOOTHILL BLVD #200, CUPERTINO, CA, 95014, US

(73) Assignee: AdBrite, Inc.

(21) Appl. No.: 11/592,037

(22) Filed: Nov. 2, 2006

(51) Int. Cl. H04N 7/10

(52) U.S. Cl. 725/35

(57) ABSTRACT

Playing video content together with an advertisement is disclosed. A first message is sent to a video player server indicating a video content. A video player is instantiated to play the video content. A second message is initiated from the video player to an advertisement server. One or more advertisements is/are received from the advertisement server. The video content is played together with the one or more advertisements using the video player.

### BACKGROUND OF THE INVENTION

Internet advertisement can be used to generate revenue for a web site owner. Current click models for advertisement are organized around space available on the web page. With the increasing adoption of higher speed links for internet access, video content is increasingly available on web sites. Ideally, advertisements should also be available to be played with video content to monetize video content web sites. However, there are many formats for video content and many players that play video content so that it is difficult to address the placement of advertisements with a piece of video content. One solution would be to standardized video content format or video content players in order to provide a uniform experience for added video advertisements. However, standardization is difficult in an already existing fragmented market with many pieces of content already available on the Internet, many creation tools for video content already available, many players already available, and many formats for the content already distributed. It would be beneficial to be able to place advertisements with web site available video content without making all the video formats or creation tools uniform.

### BRIEF DESCRIPTION OF THE DRAWINGS

Various embodiments of the invention are disclosed in the following detailed description and the accompanying drawings.

FIG. 1 is a block diagram illustrating an embodiment of a system for playing video content together with advertisement.

FIG. 2 is a flow diagram illustrating an embodiment of a process for playing video content together with advertisement.

FIG. 3 is a flow diagram illustrating an embodiment of a process for registering video content to play with an advertisement.

FIG. 4 is a flow diagram illustrating an embodiment of a process for playing video content with advertisement.

FIG. 5 is a flow diagram illustrating an embodiment of a process for acquiring a player to play video content and associated advertisement.

FIG. 6 is a flow diagram illustrating an embodiment of a process for running a player to view video content and associated advertisement.

FIG. 7 is a block diagram illustrating an embodiment of a player appearance in one embodiment.

FIG. 8A and 8B are block diagrams illustrating of a player appearance in an embodiment.

FIGS. 9A through 9N are block diagrams illustrating playing video content with advertisement in one embodiment.

### DETAILED DESCRIPTION

The invention can be implemented in numerous ways, including as a process, an apparatus, a system, a composition of matter, a computer readable medium such as a computer readable storage medium or a computer network wherein program instructions are sent over optical or communication links. In this specification, these implementations, or any other form that the invention may take, may be referred to as techniques. A component such as a processor or a memory described as being configured to perform a task includes both a general component that is temporarily configured to perform the task at a given time or a specific component that is manufactured to perform the task. In general, the order of the steps of disclosed processes may be altered within the scope of the invention.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Playing video content together with advertisement is disclosed. A first message is sent to a video player server indicating a video content. A video player is instantiated to play the video content. A second message is initiated from the video player to an advertisement server. An advertisement is received from the advertisement server. The video content is played together with the advertisement using the video player.

In some embodiments, a web site includes video content. A user navigates to the web site and the web site includes an indication that a piece of video content is available for viewing. The video content is registered with the advertisement server and/or a video player server. The video player server provides or instantiates a video player to play the video content and an advertisement. In various embodiments, the provided video player is downloaded to the user, is an applet downloaded to the user, is an applet downloaded to run on the user's web browser, is a Java, Ajax, or flash application that is loaded from the player server that runs on the user's web browser and plays the video content, or any other appropriate manner of loading the player so that the user can be enabled to view the video content and an advertisement. The advertisement server provides one or more advertisements (or one or more types of advertisements) to be played with the video content when a user indicates to the site that it is desired that the video content be played. In various embodiments, one or more advertisements or one or more types of advertisements (e.g., advertisements about golf equipment for a golf video, skate board equipment ads for a skateboard video, etc.) are selected or approved as acceptable during the registration for playing with a registered piece of video content.

In some embodiments, the playing of the video with an advertisement is reported for tracking purposes. In some embodiments, the web site is compensated (e.g., paid) for playing a reported played advertisement. In various embodiments, the advertisement is selected by the advertisement server based at least in part on one or more of the following: a keyword associated with the video content, a tag associated with the video content, the video content, a demographic estimation of the view of the video content, a behavior estimation of the viewer of the video content, or any other appropriate advertisement selection criteria.

In some embodiments, the video content is included in the instantiated video player that is associated with the site where a user selects the video to be played. In some embodiments, the video content is downloaded from a video content server.

In various embodiments, playing video content with advertisements comprises one or more of the following: playing one or more advertisements before the video content, playing one or more advertisements after the video content, playing one or more advertisements during the playing of the video content, playing one or more advertisements in the middle of the video content.

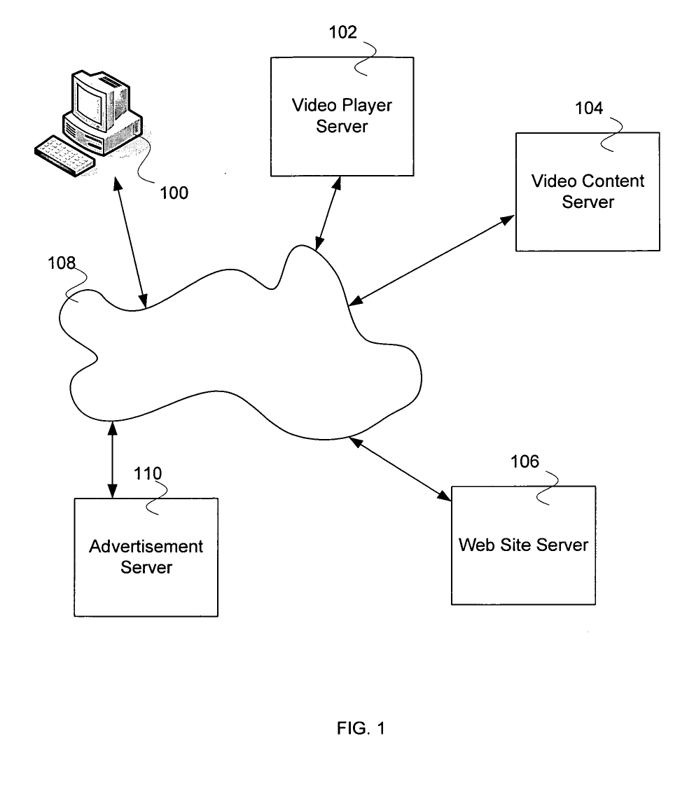

FIG. 1 is a block diagram illustrating an embodiment of a system for playing video content together with advertisement. In the example shown, a user using a web browser, represented by computer 100 in FIG. 1, is in communication with network 108. In various embodiments, network 108 comprises a wireless network, a wired network, a local area network, a wide area network, the Internet, or any other appropriate network for enabling communication between a user and servers. Video player server 102, video content server 104, web site server 106, and advertisement server 110 are all in communication with network 108. In some embodiments, a user, using computer 100, visits a web site hosted by web site server 106 containing video content.

In some embodiments, the video content is selected for viewing by the user. The video content selected by the user is associated with one or more advertisements or one or more types of advertisements. The selection of the user to view the video content causes a video player to be instantiated on computer 100 (e.g., a player run as an applet in the browser used to view the web site). The video player is downloaded from a video player server 102. The video player retrieves the desired video content from video content server 104 and an associated advertisement from advertisement server 110. The poster of the video content on the web site, when associating the video content with advertisement(s) (e.g., during a registration process), can select keywords, tags, specific advertisement, types of advertisements, demographics, player preferences (e.g., video size, autoplay features, player attributes, sharing privileges, player dimensions, etc.), or any other appropriate preferences and/or attributes desired to be associated with the video content and its display. The video player plays the video content and associated advertisement, monitors the playing, an reports the playing experience and any user action (e.g., selecting to view more information on an advertisement, stopping the viewing of the video content or the advertisement, reviewing the advertisement or video content, etc.).

In various embodiments, all the servers can be separate or any one or more of the servers (e.g., video player server 102, video content server 104, web site server 106, and advertisement server 110) can be the combined into one physical computer system—for example, video player server 102 and advertisement server 110 are combined or video content server and web site server 106 are combined.

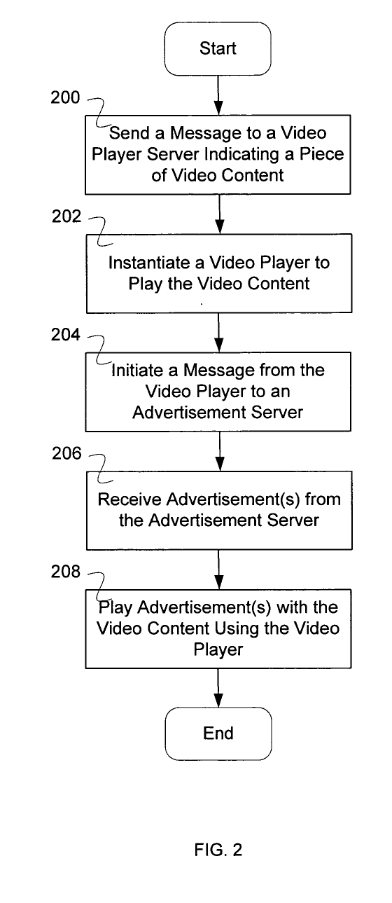

FIG. 2 is a flow diagram illustrating an embodiment of a process for playing video content together with advertisement. In some embodiments, the process of FIG. 2 is executed on a user system such as computer 100 in FIG. 1. In the example shown, in 200 a message is sent to a video player server indicating a piece of video content. In some embodiments, a piece of video content is indicated by clicking or other selection as being desired to be viewed. In 202, a video player is instantiated to play the video content. In some embodiments, the indicated video content link indicates a link to a video content player, which is then downloaded to play the video content. In 204, a message is initiated from the video player to an advertisement server. In some embodiments, the video player indicates to the advertisement server the video content to be played and the advertisement server based at least in part on the video content to be played selects one or more advertisements to be played with the video content. In 206, advertisement(s) is/are received from the advertisement server. In 208, the advertisement(s) are played with the video content using the video player. In various embodiments the advertisement(s) is/are played before, during, in the middle of, or after the video content. In various embodiments, the advertisement(s) are played in the same window as the video content, in a separate window from the video content, as a window inside the video content window, or any other appropriate manner of displaying the advertisement with the video content.

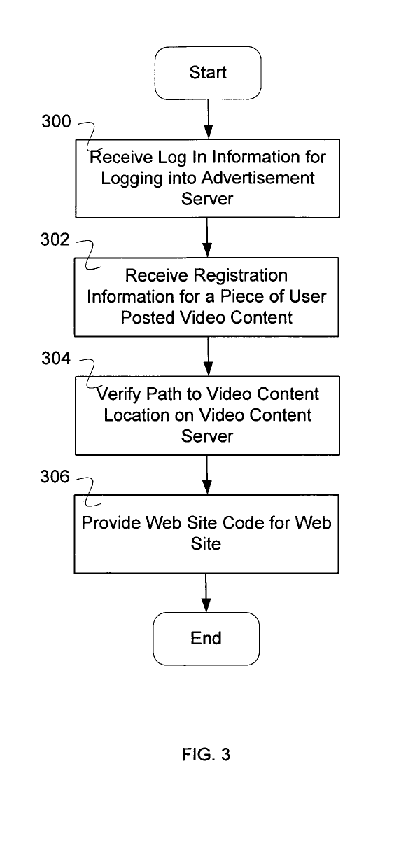

FIG. 3 is a flow diagram illustrating an embodiment of a process for registering video content to play with an advertisement. In some embodiments, the process of FIG. 3 is executed before the process of FIG. 2. In the example shown, in 300, log in information is received for logging into advertisement server. In 302, registration information is received for a piece of user posted video content. Registration can include video tags, video keywords, site keywords, tags, dimensions of video, dimensions of video player, ad configuration preferences, play preferences (e.g., autoplay, multiple play, controls for playing, etc.), content privileges (e.g., email forwarding to other users), or any other appropriate registration information. In 304, path is verified to video content location on video content server. In some embodiments, if the path fails to verify, then the poster of the video content is asked again for a path to the posted video content. In 306, web site code (e.g., HTML or any other appropriate code) is provided for web site of posted video content. In some embodiments, the web site code comprises code for adding, displaying, and embedding a video player into a web page on a website.

In some embodiments, video content is uploaded to a server and hosted by the server, and the web site code is provided for web site that points to video content hosted on the server. In some embodiments, video content is converted to an appropriate format for video player (e.g., a .flv format file).

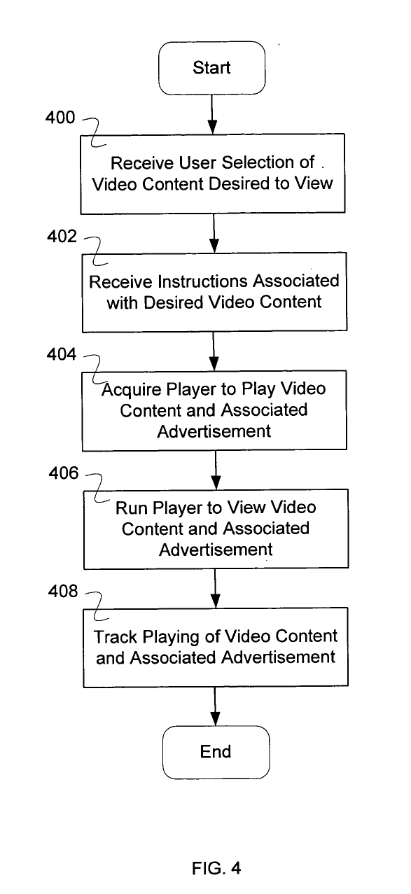

FIG. 4 is a flow diagram illustrating an embodiment of a process for playing video content with advertisement. In some embodiments, the process of FIG. 4 is executed on a user system such as computer 100 in FIG. 1. In the example shown, in 400 a user selection of video content that is desired to be viewed is received. In 402, instructions associated with the desired video content are received. In various embodiments, the instructions are in the form of HTML code, XML code, or any other appropriate code language for transferring data across a network. The instructions relate to the retrieval of a player enabled to play the video content and associated advertisement. In various embodiments, the instructions include a unique identifier for the video content, a URL for the video content, a preference settings file for the desired player configuration and/or associated advertisement, or any other appropriate information for enabling a player to play video content and associated advertisement. In 404, a player to play video content and associated advertisement is acquired. In 406, a player is run to view video content and associated advertisement. In 408, the playing of the video content and associated advertisement is tracked. In some embodiments, tracking includes recording and reporting user actions (e.g., stopping, replaying, pausing, selecting of associated material, etc.) during the playing of the video content and associated advertisement.

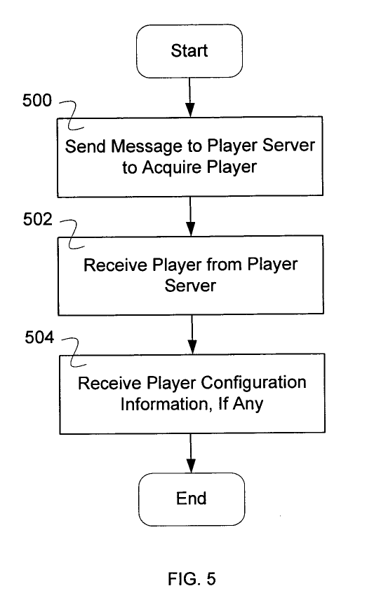

FIG. 5 is a flow diagram illustrating an embodiment of a process for acquiring a player to play video content and associated advertisement. In some embodiments, the process of FIG. 5 is used to implement 404 of FIG. 4. In the example shown, in 500 a message is sent to a player server to acquire a player. In 502, a player is received from the player server. In 504, player configuration information is received, if any. In some embodiments, player configuration includes player size, player appearance, player features, player controls available (e.g., fast forward, rewind, pause, etc.), advertisement display areas, advertisement display sizes, saving or sharing controls, or any other appropriate player configuration information. In some embodiments, player configuration information is bundled with the player and is acquired at the same time. In some embodiments, the player server and the advertisement server are combined.

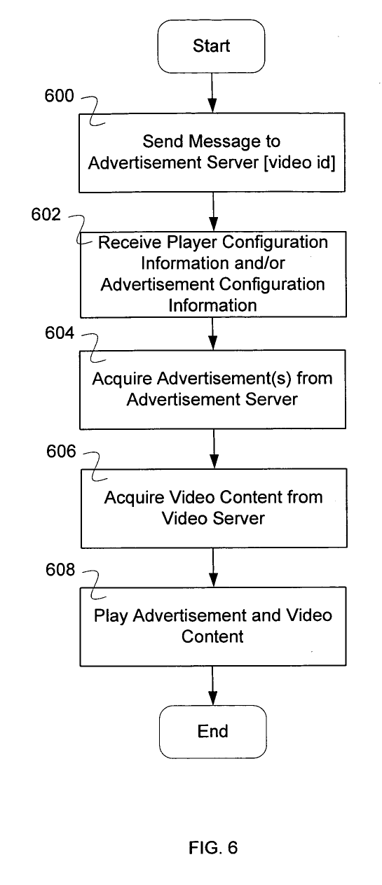

FIG. 6 is a flow diagram illustrating an embodiment of a process for running a player to view video content and associated advertisement. In some embodiments, the process of FIG. 6 is used to implement 406 of FIG. 4. In the example shown, in 600 a message is sent to an advertisement server. In some embodiments, the message includes a video content identifier. In 602, advertisement configuration information is received and/or player configuration information is received. In some embodiments, player configuration information is received, and if advertisement(s) is/are included according to the player configuration, then a second request is sent (e.g., XML) to receive advertisement configuration information from an advertising server. In 604, advertisement(s) are acquired from a advertisement server. In 606, video content is acquired form a video server. In 608, advertisement(s) and video content are played by the player.

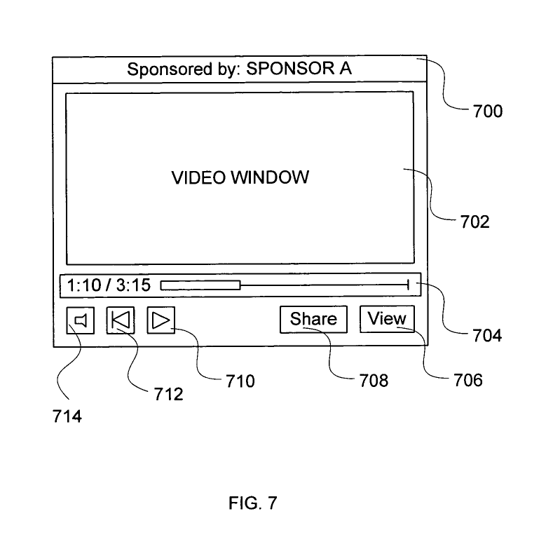

FIG. 7 is a block diagram illustrating an embodiment of a player appearance in one embodiment. In some embodiments, the appearance of the player in FIG. 7 is used for the video player used to play video content and advertisements as referred to in the process of FIG. 2. In various embodiments, the appearance of the player in FIG. 7 is used to play an advertisement before, in the middle of, or after playing video content. In the example shown, video player includes sponsor text area 700, video playing window 702, progress bar and progress time indicating area 704, view button 706, share button 708, play button 710, rewind button 712, and volume button 714. View button 706 includes options for setting a full screen view or the original size view, and learning about the video. Share button 708 includes options for selecting to email the video, link to the video, and embed the video in an HTML page. In some embodiments, sponsor text area comprises an area that when the cursor rolls over the sponsor text area (or the area is clicked on), the screen view shows the sponsor ad in a split screen or a separate screen. Sponsor text area also includes a link that when clicked on opens a window or sends a navigation command to an already open window to navigate to a sponsor web site. In some embodiments, another area of the player comprises an interactive area that when the cursor rolls over the sponsor text area (or the area is clicked on), the screen view shows a sponsor ad in a split screen or a separate screen.

In some embodiments, volume button 714 allows a user to mute the volume as well as adjust the volume of the playing audio track that is associated with the playing video content and advertisement. In some embodiments, sponsor text area 700 includes a button to sponsor the video. In some embodiments, learning about the video using view button 706 includes information such as video title, video author, video description, video host, sponsor link, advertisement enabler link, etc.

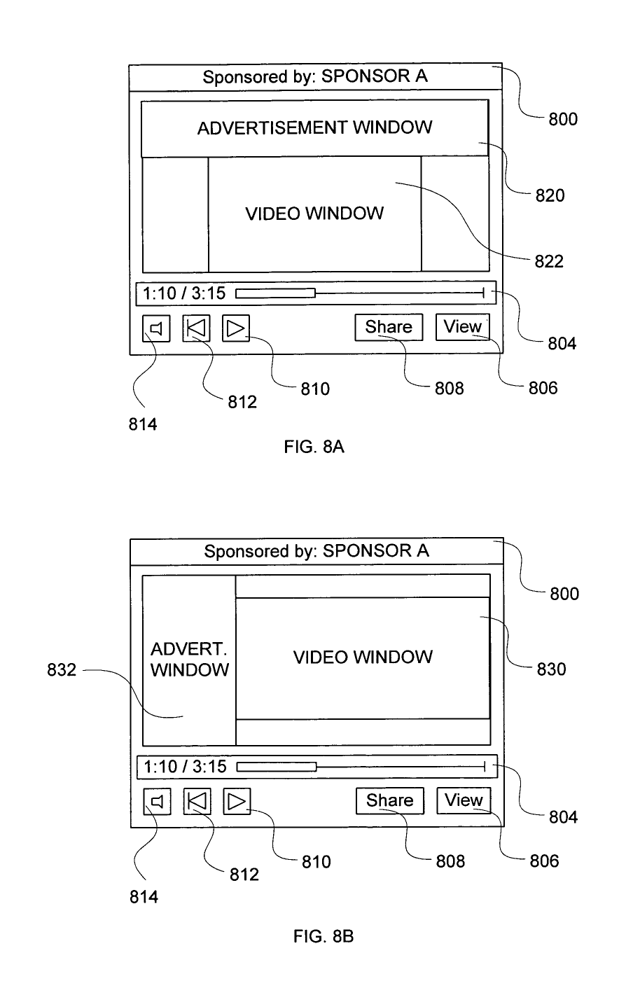

FIGS. 8A and 8B are block diagrams illustrating of a player appearance in an embodiment. In some embodiments, the appearance of the player in FIG. 8 is used for the video player used to play video content and advertisements as referred to in the process of FIG. 2. In various embodiments, the appearance of player in FIGS. 8A or 8B is used to play advertisement, before, after, in the middle of, or during the playing of video content. In the example shown, FIGS. 8A and 8B include simultaneously visible advertisement and video windows. In various embodiments, the advertisement windows and the video window are above and below each other, side by side each other, picture in picture with each other (not shown), in separate pop windows (not shown), or any other appropriate configuration for simultaneously visible windows. In the example shown, an appearance of the video player includes sponsor text area 800, video playing windows 822 and 830, separate advertisement windows 820 and 832, a progress bar and progress time indicating area 804, view button 806, share button 808, play button 810, rewind button 812, and volume button 814. View button 806 includes options for setting a full screen view or the original size view, and learning about the video. Share button 808 includes options for selecting to email the video, link the video, and embed the video. In various embodiments, separate advertisement windows 820 and 832 display video advertisements, text advertisement, flash advertisements, or any other appropriately formatted advertisements to play before, after, during, or in the middle of video content.

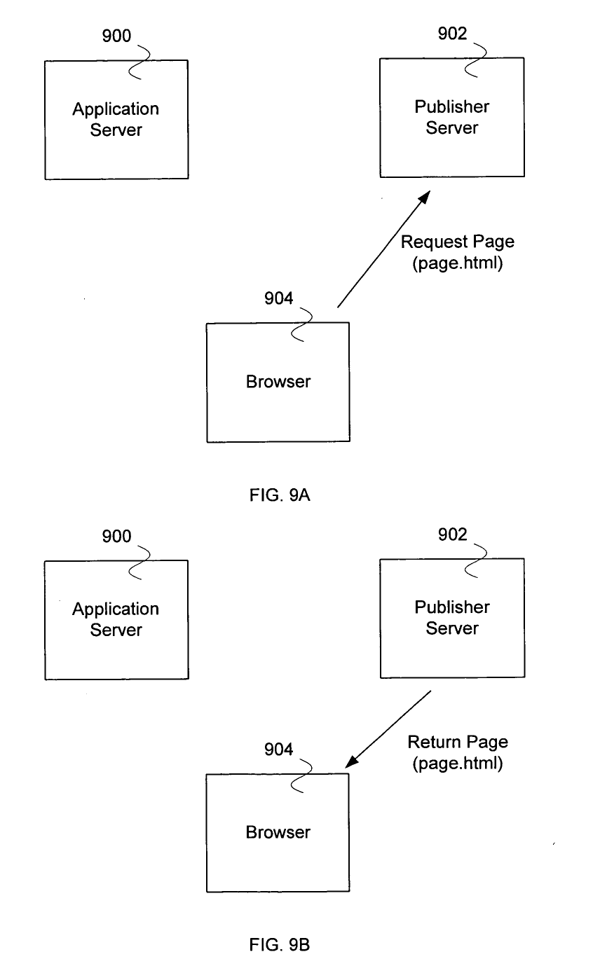

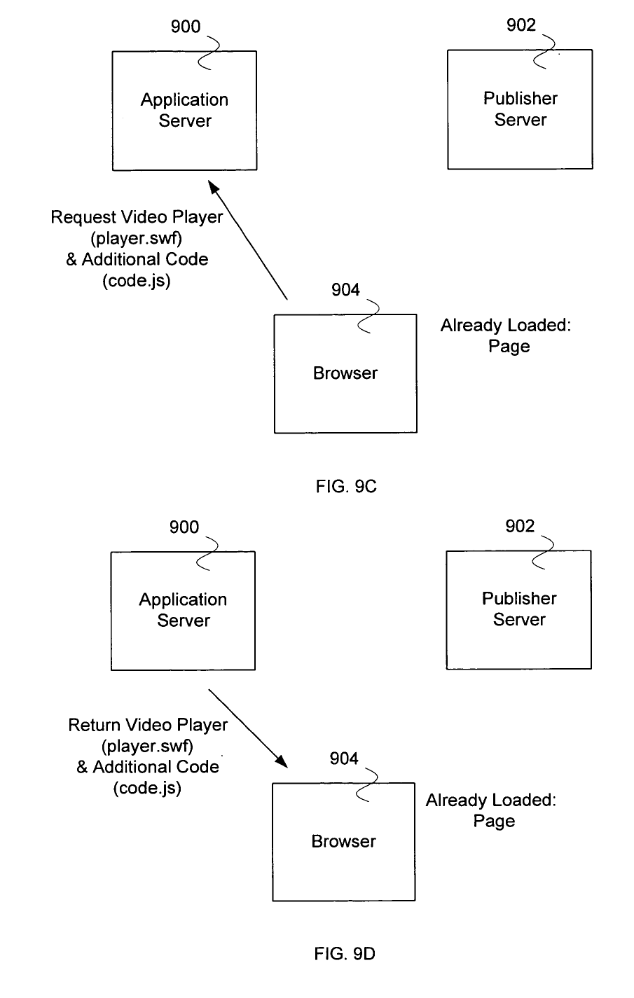

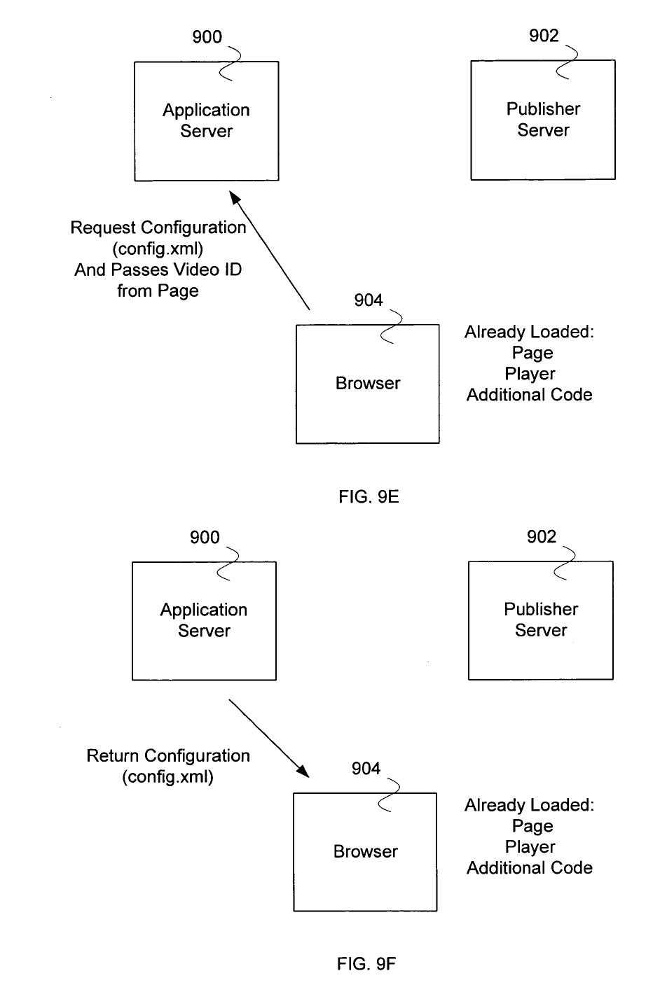

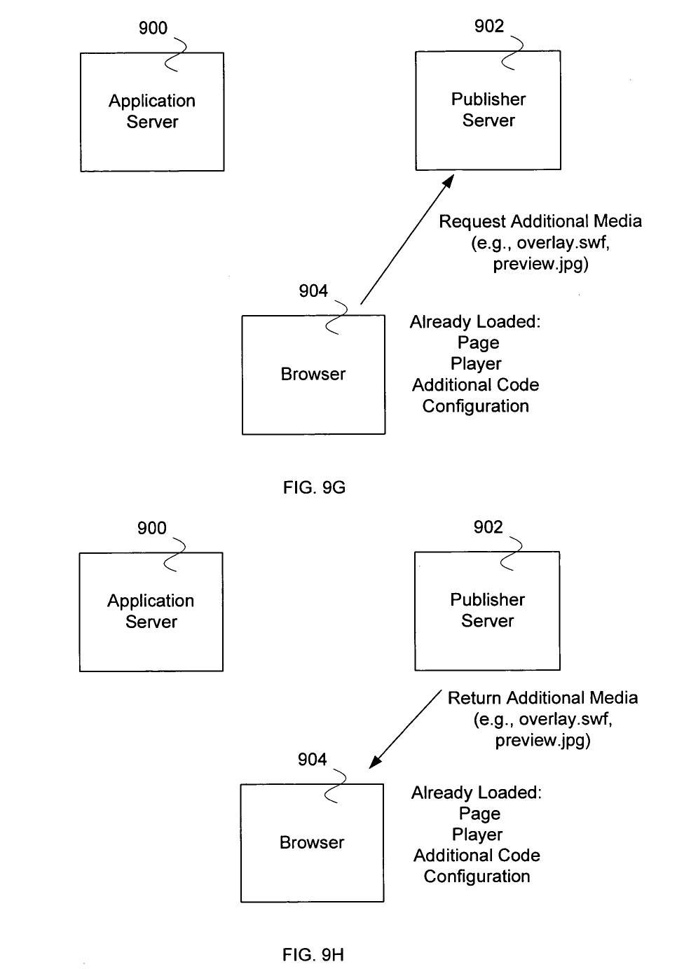

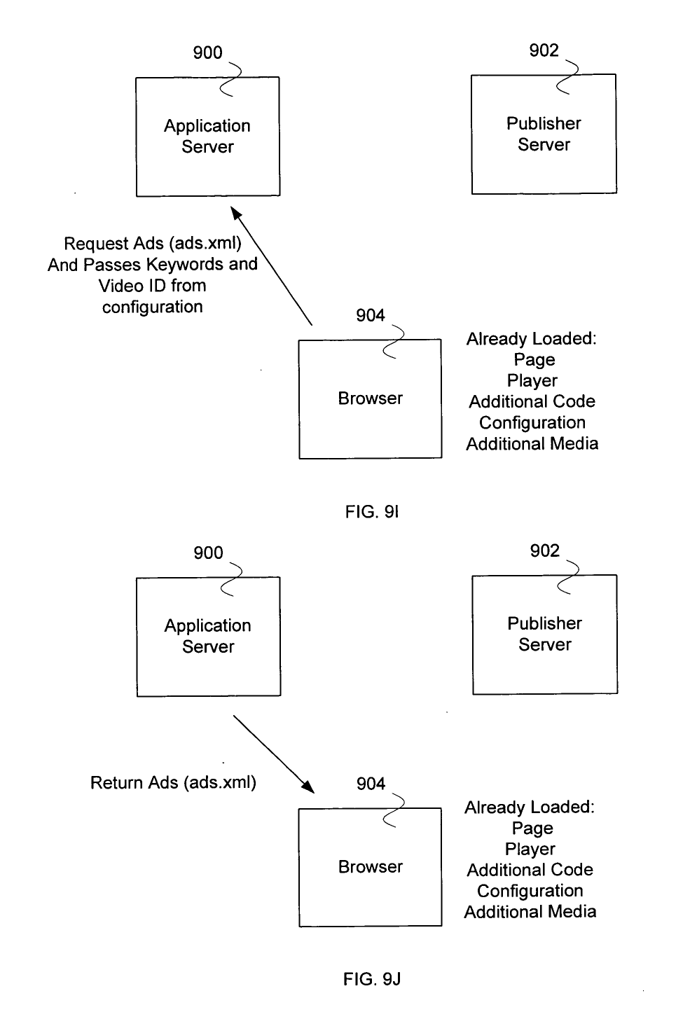

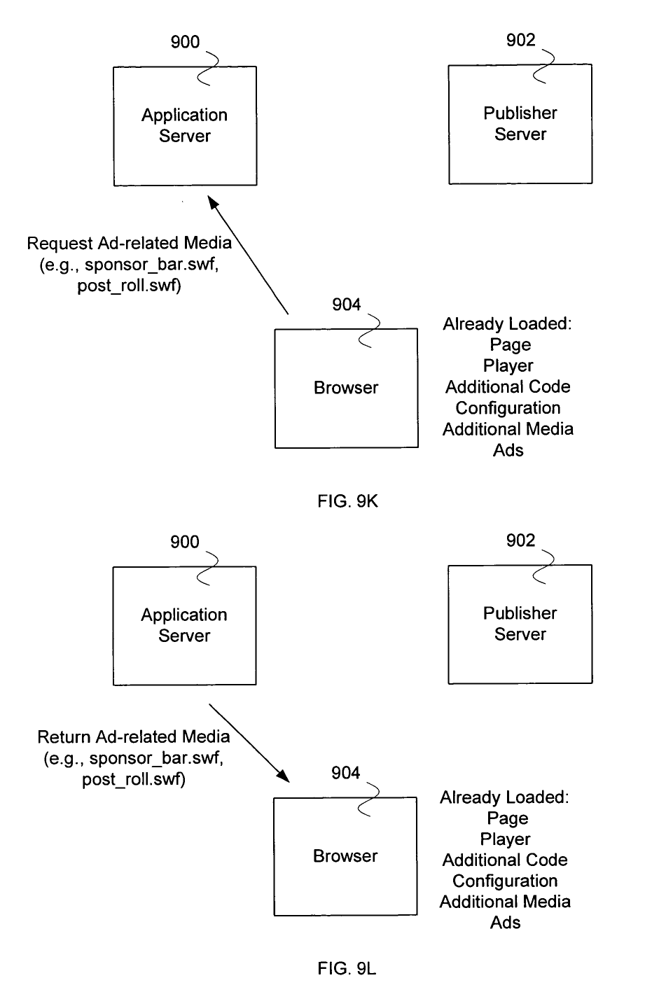

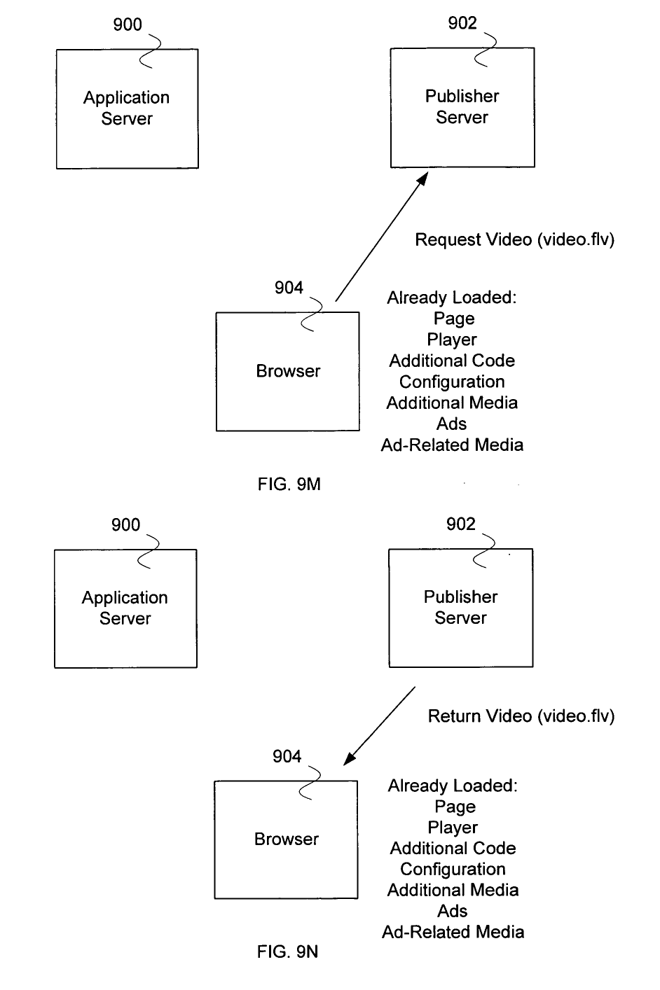

FIGS. 9A through 9N are block diagrams illustrating playing video content with advertisement in one embodiment. FIGS. 9A through 9N include application server 900, publisher server 902, and browser 904. In some embodiments, a user using browser 904 selects a video to play at a publisher's web site. The publisher has selected to include advertisement (s) enabled by application server 900. Application server provides a player and ad content. In the example shown, in FIG. 9A a user using browser 904 requests a web page from publisher server 902 (e.g., publisher.com). In FIG. 9B, publisher server 902 returns the page (e.g., page HTML code: page.html), which includes references to a video player, a video ID, and additional code that is used by the video player. In some embodiments, a reference to additional code is not included.

In FIG. 9C, browser 904 requests video player and additional code (e.g., JavaScript functions that can be executed by the video player, extending the video player functionality by allowing the video player to interact with the host Web browser in various ways—for example, providing the ability to open a new web browser window for full-screen video playback) from application server 900. In FIG. 9D, application server 900 returns the requested video player and additional code. In FIGS. 9C and 9D, page code is already loaded in browser 904. In FIG. 9E, the video player initializes and reads a video ID that is included in the page HTML (e.g., as part of the file page.html), and sends a request for a configuration file to application server 900 along with the video ID. Application server 900 receives the request a dynamically writes configuration (e.g., an XML code file: config.xml) for browser 904. The XML code includes links to all non-advertising-related media (e.g., main video, preview image, overlay, etc.) as well as all player configuration settings (e.g., ad server URL and ad-related data used by ad server to determine which ads to serve with this video). In FIG. 9F, the browser receives the XML and the player running on browser 904 parses the XML. The player configures itself according to the configuration information. In FIGS. 9E and 9F, page code, player code, and additional code are already loaded in browser 904.

In FIG. 9G, additional media files are requested from publisher server 902 (e.g., overlay.swf and preview.jpg). In FIG. 9H, the additional media files are returned and loaded into video player. In FIGS. 9G and 9H, page code, player code, additional code, and configuration are already loaded in browser 904.

In FIG. 9I, the configuration file indicates that ads are shown with the video to be played, and a request is sent to application server 900 to retrieve the ads along with related information from the configuration file (e.g., keywords, video ID, etc.). In FIG. 9J, application server 900 dynamically prepares and returns ad XML files using information received. Ad XML file includes links to advertising related media required to be shown (e.g., flash, images, etc.) as well as text to be displayed and any configuration settings for the ads. In FIGS. 9I and 9J, page code, player code, additional code, configuration, and additional media are already loaded in browser 904.

In FIG. 9K, video player requests from application server 900 all ad-related media (e.g., sponsor.swf, post_roll.swf). In FIG. 9L, the requested media are received and loaded. In FIGS. 9K and 9L, page code, player code, additional code, configuration, additional media, and ads are already loaded in browser 904.

In FIG. 9M, the video player becomes active for the user. Depending on the configuration the video is either automatically loaded or loaded when the user initiates playback by interacting with the player (e.g., clicks a “play” button, or some other interactive area or control on the player). In FIG. 9N, the video is returned and is streamed to the video player. Playback of the video and advertisement begins once enough of the video has buffered to allow continuous play to the end of the video without interruption at the user's current available network bandwidth. In FIGS. 9M and 9N, page code, player code, additional code, configuration, additional media, ads, and ad-related media are already loaded in browser 904.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method of playing video content together with an advertisement comprising:
sending a first message to a video player server indicating a video content;
instantiating a video player to play the video content;
initiating a second message from the video player to an advertisement server;
receiving one or more advertisements from the advertisement server; and
playing the video content together with the one or more advertisements using the video player.

2. A method as in claim 1, further comprising:
initiating a third message from the video player to a video player server; and
receiving configuration information from the video player server.

3. A method as in claim 1, wherein instantiating the video player comprises:
receiving a video player; and
receiving configuration information.

4. A method as in claim 1, wherein the first message is sent from a user using a web browser.

5. A method as in claim 1, wherein the video content is located on a web site.

6. A method as in claim 1, wherein the video player is instantiated by downloading the video player from the video player server.

7. A method as in claim 1, further comprising registering the video content with the advertisement server.

8. A method as in claim 1, further comprising registering the video content with the advertisement server and wherein registering includes selecting one or more advertisements that are acceptable to be played with the registered video content.

9. A method as in claim 1, further comprising registering the video content with the advertisement server and wherein registering includes selecting one or more types of advertisements that are acceptable to be played with the registered video content.

10. A method as in claim 1, further comprising reporting the playing of the video content together with the advertisement.

11. A method as in claim 1, wherein the advertisement is selected by the advertisement server based at least in part on a keyword associated with the video content.

12. A method as in claim 1, wherein the advertisement is selected by the advertisement server based at least in part on a tag associated with the video content.

13. A method as in claim 1, wherein the advertisement is selected by the advertisement server based at least in part on the video content.

14. A method as in claim 1, wherein the advertisement is selected by the advertisement server based at least in part on a demographic estimation of the viewer of the video content.

15. A method as in claim 1, wherein the advertisement is selected by the advertisement server based at least in part on a behavior estimation of the viewer of the video content.

16. A method as in claim 1, wherein the video content is included with the video player.

17. A method as in claim 1, wherein the video content is downloaded from a video content server.

18. A method as in claim 1, wherein playing the video content together with the one or more advertisements comprises one or more of the following: playing one or more advertisements before the video content, playing one or more advertisements after the video content, playing one or more advertisements during the playing of the video content, playing one or more advertisements in the middle of the video content.

19. A method as in claim 1, wherein the advertisement is displayed in an advertisement window associated with the video player and the video content is displayed in a video window associated with the video player.

20. A method as in claim 19, wherein the advertisement window and the video window have one of the following configurations: the advertisement windows and the video window are above and below each other, side by side each other, picture in picture with each other, or in separate pop windows.

21. A method as in claim 19, wherein the advertisement window appears when one or more of the following occurs: a cursor rolls over a sponsor text area, a sponsor text area is clicked on, a cursor rolls over an interactive area of the player, or a cursor clicks on an interactive area of the player.

22. A computer program product for playing video content together with an advertisement, the computer program product being embodied in a computer readable medium and comprising computer instructions for:
sending a first message to a server indicating a video content;
instantiating a video player to play the video content;
initiating a second message from the video player to an advertisement server;
receiving one or more advertisements from the advertisement server; and
playing the video content together with the one or more advertisements using the video player.

23. A system for playing video content together with an advertisement comprising:
a processor; and
a memory coupled with the processor, wherein the memory is configured to provide the processor with instructions which when executed cause the processor to:
send a first message to a server indicating a video content;
instantiate a video player to play the video content;
initiate a second message from the video player to an advertisement server;
receive one or more advertisements from the advertisement server; and
play the video content together with the one or more advertisements using the video player.
